(19) United States
(12) Patent Application Publication
(10) Pub. No.: US 2026/0114350 A1
(43) Pub. Date: Apr. 30, 2026

(54) Weeding Apparatus

(71) Applicant: Harvest Moon Automation Inc., Winchester, MA (US)

(72) Inventors: Stephen C. Jens, Winchester, MA (US); Janice Huxley Jens, Winchester, MA (US)

(21) Appl. No.: 19/365,981

(22) Filed: Oct. 22, 2025

Related U.S. Application Data
(60) Provisional application No. 63/712,407, filed on Oct. 26, 2024.

(51) Int. Cl. A01B 39/18; A01B 1/16

(52) U.S. Cl. CPC A01B 39/18; A01B 1/16

(57) ABSTRACT

A weeding apparatus including a duct having a vacuum port for suctioning by vacuum at least a portion of a weed into the vacuum port. A weed pulling assembly can be positioned within the vacuum port for pulling the weed through the vacuum port in a downstream direction. The weed pulling assembly can include two opposing weed pulling driveable rotary members for clamping and rotatably pulling the weed therebetween. The two driveable rotary members can be moveable relative to each other between a spaced apart position for allowing the weed to be suctioned therebetween, and a position for contacting and rotatably pulling the weed. Each driveable rotary member can be rotatably mounted about a respective rotatable driveable axle. The driveable axles can be moveable relative to each other towards and away from each other.

### RELATED APPLICATION

This application claims the benefit of U.S. Provisional Application No. 63/712,407, filed on Oct. 26, 2024. The entire teachings of the above application are incorporated herein by reference.

### BACKGROUND

Weed management is one of the major cost factors in growing crops. The weeds compete for the same nutrients, water and sunlight that is critical for raising healthy crops. Conventional vegetable growers typically use herbicides to combat weeds. Organic vegetable growers cannot use the same herbicides. Herbicides acceptable for organic crops have not been effective and are not widely used. Consequently, manual labor is the primary method to remove weeds from organic fields. In addition, conventional farms also rely on manual labor to remove herbicide resistant weeds. These herbicide-resistant “super weeds” are a growing problem for conventional farms and require more labor to remove.

In response to the growing need for automation in weed control, there have been advances in technology to detect and kill weeds. However, many of these advances still depend upon chemicals or soil tillage for weed control. Both of these agricultural practices have a negative impact on climate, soil sustainability, surface/ground water quality and the health of the farmer. Herbicide usage negatively impacts the microbial environment of the soil, contaminates the surface/ground water and the health of the farmers who apply the herbicide. Similarly, soil tillage also negatively impacts the soil microbial environment and exposes the organic matter in the soil to oxidation which releases carbon dioxide into the atmosphere. Consequently, advances in weed control with automation need to find solutions that do not use herbicides or soil tillage.

Recent advances in automated weed control have made progress in controlling early-stage weeds without using herbicides or soil tillage. However, at this time there is no automated weed control system that eliminates weeds in the mid-to-later-stage weed growth without using herbicides or soil tillage. The only option for removing weeds in the mid-to-later-stage weed growth is manual labor if growers do not want to use herbicides or soil tillage.

### SUMMARY

Embodiments of a weeding apparatus, device, automated precision weeder, or weeder in the present disclosure, can eliminate mid-to-later-stage weeds without the use of herbicides or soil tillage. It can operate with a vision-controlled extraction tool that can precisely remove a weed without disrupting the surrounding soil or neighboring plants. A technological innovation required for developing a successful weeder is an effective mechanical extraction end effector tool. The tool has uniquely challenging design constraints including killing and extracting the weed without damage to neighboring plants and soil. If it damages the surrounding crop, it will decrease the yield. If it disrupts the surrounding soil, it will cause damage to the soil microbial environment, cause unwanted carbon dioxide release, and decrease soil sustainability. Weed control, especially for organic crops, typically uses a system of cover crops, mulch, and minimal disruption to the soil to suppress the weeds and keep the weed seeds in the soil from germinating. The weeder can target and extract the weeds without disturbing the soil cover, mulch or soil. The unique attributes of the weeder can ensure that weeds are precisely killed and removed without using chemicals or soil tillage.

The present disclosure can provide a weeding apparatus, device, precision weeder, or weeder, including a duct having a vacuum port for suctioning by vacuum at least a portion of a weed into the vacuum port. A weed pulling assembly can be positioned within the vacuum port for pulling the weed through the vacuum port in a downstream direction. The weed pulling assembly can include two opposing weed pulling driveable rotary members for clamping and rotatably pulling the weed therebetween. The two driveable rotary members can be moveable relative to each other between a spaced apart position for allowing the weed to be suctioned therebetween, and a position for contacting and rotatably pulling the weed. Each driveable rotary member can be rotatably mounted about a respective rotatable driveable axle. The driveable axles can be moveable relative to each other towards and away from each other.

In particular embodiments, the weed pulling assembly can further include a linkage assembly to which at least one of the driveable axles is rotatably mounted. The linkage assembly can move the two driveable rotary members towards and away from each other. The linkage assembly can include a pivoting arm having proximal and distal ends. The pivoting arm can be pivotable about a pivot joint at the proximal end. One driveable axle can be rotatably mounted to the distal end, and the pivoting arm can be pivotably moveable by an actuator. A cutting assembly can be mounted adjacent to the vacuum port for cutting roots of the weed. In some embodiments, the cutting assembly can include a rotary saw blade. A vacuum device can be in communication with a weed receptacle that is connected to the vacuum port by a vacuum conduit, for conveying the pulled weed from the vacuum port by vacuum through the vacuum conduit into the weed receptacle for storing the pulled weed. A vacuum diverter can be positioned downstream from the weed pulling assembly for controllably diverting vacuum from the vacuum port to a position downstream from the weed pulling assembly. A filter can be associated with the weed receptacle for retaining seeds from the pulled weed in the weed receptacle. In some embodiments, a backpack can be worn by a user for carrying the vacuum device and the weed receptacle. In other embodiments, a movable carriage can convey the vacuum device and the weed receptacle. In some embodiments, the vacuum port with the weed pulling assembly can be connected to a movable robotic arm mounted to the movable carriage. A controller can control operation of the weeding apparatus. A vision system can guide positioning of the robotic arm and the vacuum port. At least two robotic arms can be mounted to the movable carriage, and each robotic arm can be connected to a respective vacuum port having a weed pulling assembly. In some embodiments, the weed pulling assembly can have a housing including the duct. The vacuum port can have a weed entry port and a weed exit port, with a flow path therebetween. The weed entry port and the weed exit port can have dimensions that enable suctioning by vacuum through the flow path. The weed pulling assembly can be positioned in fluid communication with the weed entry port and the weed exit port. The weed pulling assembly can be configured to apply a mechanical pulling force to the at least a portion of the weed drawn into the weed entry port of the vacuum port, and to release the weed into the flow path toward the weed exit port.

The present disclosure can also provide a weeding apparatus including a duct having a vacuum port for suctioning by vacuum at least a portion of a weed into the vacuum port. A weed pulling assembly can be positioned within the vacuum port for pulling the weed through the vacuum port in a downstream direction. The weed pulling assembly can include two opposing weed pulling driveable rotary members for clamping and rotatably pulling the weed therebetween. The two driveable rotary members can be moveable relative to each other between a spaced apart position for allowing the weed to be suctioned therebetween, and a position for contacting and rotatably pulling the weed. Each driveable rotary member can be rotatably mounted about a respective rotatable driveable axle. The driveable axles can be rotatably mounted to a linkage assembly. The linkage assembly can move the two driveable rotary members relative to each other towards and away from each other. A vacuum device can be in communication with a weed receptacle that is connected to the vacuum port by a vacuum conduit, for conveying the pulled weed from the vacuum port by vacuum through the vacuum conduit into the weed receptacle for storing the pulled weed. A backpack can carry the vacuum device and the weed receptacle when worn by a user.

In particular embodiments, the weeding apparatus can further include a cutting assembly comprising a rotary saw blade mounted adjacent to the vacuum port for cutting roots of the weed.

The present disclosure can also provide a weeding apparatus include a movable carriage and a robotic arm mounted to the movable carriage. A duct having a vacuum port can be mounted to the robotic arm for suctioning by vacuum at least a portion of a weed into the vacuum port. A weed pulling assembly can be positioned within the vacuum port for pulling the weed through the vacuum port in a downstream direction. The weed pulling assembly can include two opposing weed pulling driveable rotary members for clamping and rotatably pulling the weed therebetween. The two driveable rotary members can be moveable relative to each other between a spaced apart position for allowing the weed to be suctioned therebetween, and a position for contacting and rotatably pulling the weed. Each driveable rotary member can be rotatably mounted about a respective rotatable driveable axle. The driveable axles can be moveable relative to each other towards and away from each other. A vacuum device can be in communication with a weed receptacle that is connected to the vacuum port by a vacuum conduit, for conveying the pulled weed from the vacuum port by vacuum through the vacuum conduit into the weed receptacle for storing the pulled weed. A controller can control operation of the weeding apparatus. A vision system can guide positioning of the robotic arm and the vacuum port.

In particular embodiments, a cutting assembly can be mounted adjacent to the vacuum port for cutting roots of the weed. In some embodiments, the cutting assembly can include a rotary saw blade. In some embodiments, at least two robotic arms can be mounted to the movable carriage. Each robotic arm can be connected to a respective vacuum port having a weed pulling assembly and a cutting assembly. The weed pulling assembly can further include a linkage assembly to which at least one of the driveable axles is rotatably mounted, for moving the two driveable rotary members towards and away from each other.

The present disclosure can also provide a method of removing weeds with a weeding apparatus, including positioning a duct having a vacuum port over a weed within soil, and suctioning at least a portion of the weed into the vacuum port by vacuum. With a weed pulling assembly positioned within the vacuum port comprising two opposing weed pulling driveable rotary members, clamping the weed between the two drivable rotary members, and rotating with the weed clamped therebetween, for pulling the weed from the soil and through the vacuum port in a downstream direction. The two driveable rotary members can be moveable relative to each other between a spaced apart position for allowing the weed to be suctioned therebetween, and a position for contacting and rotatably pulling the weed. Each driveable rotary member can be rotatably mounted about a respective rotatable driveable axle. The driveable axles can be moveable relative to each other towards and away from each other.

In particular embodiments, the weed pulling assembly can include a linkage assembly to which at least one of the driveable axles is rotatably mounted. The two driveable rotary members can be moved towards each other with the linkage assembly. The linkage assembly can include a pivoting arm having proximal and distal ends. The pivoting arm can be pivotable about a pivot joint at the proximal end. One driveable axle can be rotatably mounted to the distal end. The pivoting arm can be pivotably moved with an actuator. Roots of the weed can be cut with a cutting assembly mounted adjacent to the vacuum port. In some embodiments, the cutting assembly can include a rotary saw blade. A vacuum device can be in communication with a weed receptacle that is connected to the vacuum port by a vacuum conduit. The pulled weed can be conveyed from the vacuum port by vacuum through the vacuum conduit into the weed receptacle for storing the pulled weed. Vacuum can be controllably diverted from the vacuum port to a position downstream from the weed pulling assembly with a vacuum diverter positioned downstream from the weed pulling assembly. Seeds can be retained from the pulled weed in the weed receptacle with a filter associated with the weed receptacle. In some embodiments, the vacuum device and weed receptacle can be carried with a backpack worn by a user. In other embodiments, the vacuum device and the weed receptacle can be conveyed in a movable carriage. In some embodiments, the vacuum port with the weed pulling assembly can be connected to a movable robotic arm mounted to the movable carriage. The vacuum port can be positioned over selected weeds with the robotic arm. A controller can control operation of the weeding apparatus. Positioning of the robotic arm and vacuum port can be guided with a vision system. At least two robotic arms can be mounted to the movable carriage. Each robotic arm can be connected to a respective vacuum port having a weed pulling assembly. The at least two robotic arms can be simultaneously operated for positioning respective vacuum ports and weed pulling assemblies in different locations for pulling multiple weeds from the soil. In some embodiments, the weed pulling assembly can have a housing including the duct. The vacuum port can have a weed entry port and a weed exit port, with a flow path therebetween. The weed entry port and the weed exit port can have dimensions that enable suctioning by vacuum through the flow path. The weed pulling assembly can be positioned in fluid communication with the weed entry port and the weed exit port. A mechanical pulling force can be applied with the weed pulling assembly to the at least a portion of the weed drawn into the weed entry port, and the weed can be released into the flow path toward the weed exit port. In some embodiments, operation of the weeding apparatus can be controlled with a controller, where the weed and type of the weed seen with a vision system in communication with the controller, can be identified by comparison with a stored database of weed type characteristics. A determination can be made whether or not to cut roots of the weed with a cutting assembly mounted adjacent to the vacuum port based on the type of the weed. The vision system can identify whether or not the weed has been removed from the soil, for determining whether or not a second attempt is needed to remove the weed. The duct can be maneuvered over the weed with a robotic arm, and path movement of the robotic arm and the duct, can be determined by the stored database of weed type characteristics based on the type of the weed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic drawing of an embodiment of a weeding apparatus in the present disclosure positioned for pulling a weed.

FIG. 2 is a side view of an embodiment of a weeding head, and FIG. 3 is a side view with some portions being translucent for showing certain features.

FIG. 4 is a bottom perspective view thereof with some portions being translucent for showing certain features.

FIG. 5 is a perspective view of an embodiment of the weeding head in a crop field.

FIG. 6 is a perspective view of an embodiment of a weeding apparatus having a movable carriage, located in a crop field, and FIG. 7 is a perspective view thereof in use.

FIGS. 8A-8C are perspective views showing steps for pulling a weed with an embodiment of the weeding apparatus.

FIG. 9A is a top view of a crop plant with an adjacent weed emphasized with a surrounding frame, and FIG. 9B is a top view after removal of the weed.

FIG. 10A is a top view of two crop plants with an adjacent weed emphasized with a surrounding frame, FIG. 10B is a top view after removal of the weed, and FIG. 10C additionally shows the weeds collected in a weed receptacle.

FIG. 11 is an enlarged view of a lower portion of FIG. 3.

FIG. 12 is a schematic drawing of another embodiment of a weeding apparatus.

FIG. 12A is a schematic drawing of yet another embodiment of a weeding apparatus.

FIGS. 13 and 14 are perspective views of another embodiment of a weeding head, with the rollers and cutting blade in retracted positions, and with FIG. 14 having translucent portions to show certain interior features.

FIGS. 15 and 16 are side views of FIG. 13, with FIG. 16 having translucent portions to show certain features.

FIG. 17 is a bottom view of FIG. 15, and FIG. 18 is a bottom view showing the rollers in clamping position.

FIG. 19 is a perspective view of the weeding head having translucent portions, with the rollers clamped and the cutting blade positioned for cutting.

FIGS. 20 and 21 are side views of FIG. 19, with FIG. 21 having translucent portions.

FIG. 22 is a bottom view of FIG. 20.

FIG. 23 is a flow chart showing operation of an embodiment of a weeding apparatus.

FIGS. 24 and 25 are perspective views of another embodiment of a weeding apparatus including a tractor pulling a mobile carriage.

### DETAILED DESCRIPTION

A description of example embodiments follows.

Embodiments of the weeding apparatus, device, precision weeder, or weeder can eliminate the mid-to-late-stage weeds, and includes the features that can mechanically grab the weed, cut the root, if necessary, extract the weed from the soil and transport the weed to a weed receptacle or collection bin. In some embodiments, the weeder can include an end effector or weeding head attached to a robotic arm that can be guided by a vision system.

Embodiments of a weeder can have six or more end effectors that are independently controlled. All of the support equipment necessary to operate the weeder including power, compressed air and controls can be assembled onto a mobile platform attached to the end effectors.

In some embodiments, the end effector can be manually operated. Such a design can be lightweight and easy to maneuver. The controls can be mounted onto the handle of the weeder so that the operator could easily operate the system.

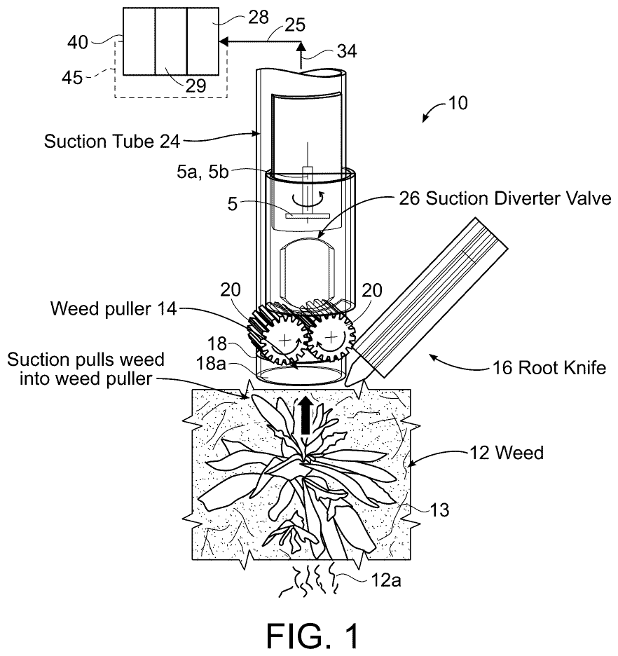

An embodiment of the weeding apparatus, device, precision weeder or weeder 10, is shown in FIG. 1. As shown in FIG. 1, the basic principle of the weeder 10 is to extract the weed 12 by using the combination of vacuum to draw the weed 12 into a weed puller, or weed pulling assembly 14 with driven rotary members, gears, rollers, roller gears or wheels 20 that can have a textured or geared profile to grip, grab and pull the weed 12, and a root knife, blade or cutting assembly 16 to sever the root 12a if necessary to make sure all of the weed 12 is extracted. This root knife 16 can be a blade or a rotating disk, such as a rotatable saw blade. A root knife 16 is not necessary for weeds 12 with a strong stem, since the entire weed 12 (including most of the root 12a) can be extracted without cutting the root 12a. On the other hand, weeds 12 with a soft and fragile stem will need to have the root 12a cut in order to extract the weed 12 with part of its root. An internal cutting assembly having a rotating cutting blade 5 driven by a rotatable shaft 5a about an axis 5b can be positioned within the housing 18 downstream from the weed puller 14 for cutting or chopping up the weed 12 into smaller pieces for enabling easier transportation of the extracted weed 12 by vacuum without clogging the suction tube 24 or any downstream tubes or hoses.

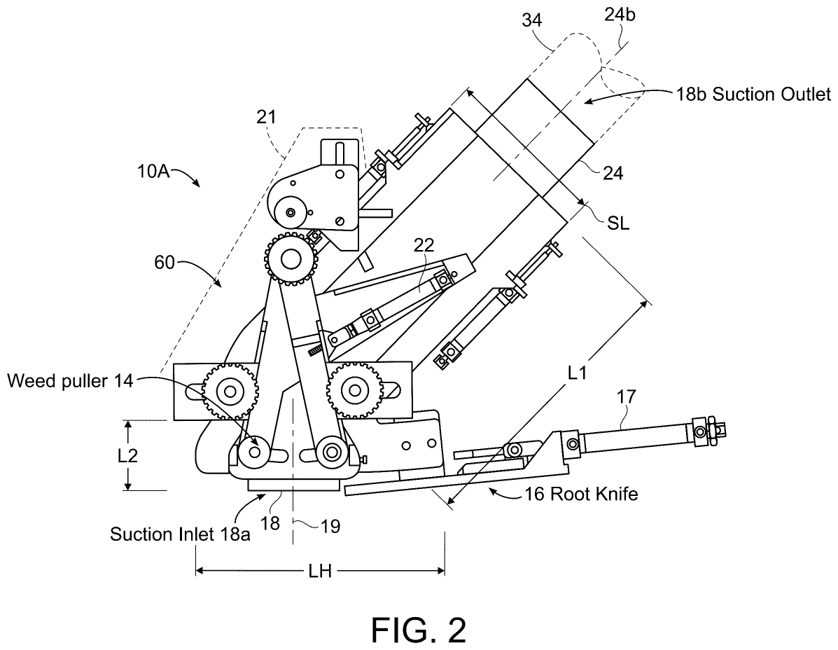

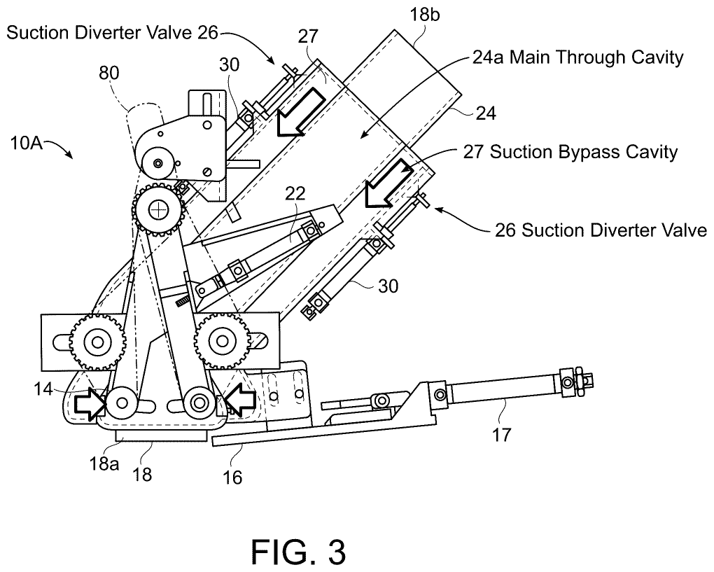

An embodiment of the end effector or weeding head 10A of weeder 10 having a main housing 18, is shown in FIG. 2. As shown in FIG. 2, the design integrates the functions that are shown in FIG. 1. The weeds 12 can be drawn into the bottom of the weeding head 10A through a bottom 2-inch diameter suction inlet or weed entry vacuum port 18a located at the base of suction tube or duct 24. Next to the suction inlet 18a can be a root cutting knife or cutting assembly 16 that can be actuated by an actuator such as a pneumatic cylinder 17 controlled by the operator. One inch above the bottom suction inlet 18a, a weed puller or weed pulling assembly 14 can be positioned including two meshing roller gears, wheels or driveable rotary members 20 that can be each driven or powered by an on-board electrical motor 80. The roller gears 20 of the weed puller 14 can be separated apart to allow the weed 12 to be pulled up by the vacuum from a vacuum generator 40 between the rollers 20 and then actuated by two actuators such as pneumatic cylinders 22 to clamp the weed 12 between the two meshing roller gears 20, extracting the weed 12 from the soil 13. After the weed 12 passes beyond the meshing roller gears 20, it is pulled by vacuum to the weed collection bin, receptacle or container 28, which can be on a mobile platform. The outlet 18b at the top of the duct 24 can be attached to a two-inch diameter vacuum tube, conduit or pipe 34 that can serve as both a handle to maneuver the weeding head 10A and a conduit for the vacuum to pull the weeds 12 to the container 28 via a flexible hose 25 connected to thereto (FIG. 7). A filter 29 can retain seeds within container 28. A suction or vacuum diverter valve 26 can be positioned on the side of duct 24 downstream from the weed pulling assembly 14 for controllably diverting vacuum from the bottom inlet 18a to a downstream position to prevent suctioning through the bottom inlet 18a when it is desired not to suction plants, thereby preventing unwanted suction of crops.

FIG. 3 shows a transparent view of an embodiment of the main housing 18 of the weeding head 10A. The main housing 18 can have a center cavity 24a that extends from the bottom inlet or weed entry port 18a to the top outlet or weed exit port 18b. This cavity 24a is where the weed 12 can travel from the weed puller 14 to the top outlet 18b, and can be considered a vacuum port extending from inlet 18a to outlet 18b. Two cavities 27 can parallel the main cavity 24a, forming bypass ducts that allow air to move from the top of the weeding head 10A to the bottom of the weeding head 10A. When these two bypass ducts 27 are opened by two respective actuators or pneumatic cylinders 30 at the top of the weeder 10, vacuum can be be shut off from the bottom inlet 18a. In effect, the vacuum can be shut on and off through the bottom inlet 18a, while allowing air flow to continue through the main cavity 24a pulling the weed 12 to the collection container 28. Turning vacuum off from the bottom inlet 18a when weeds 12 are not being extracted can prevent a crop plant from being accidentally pulled into the weeding head 10A when being maneuvered.

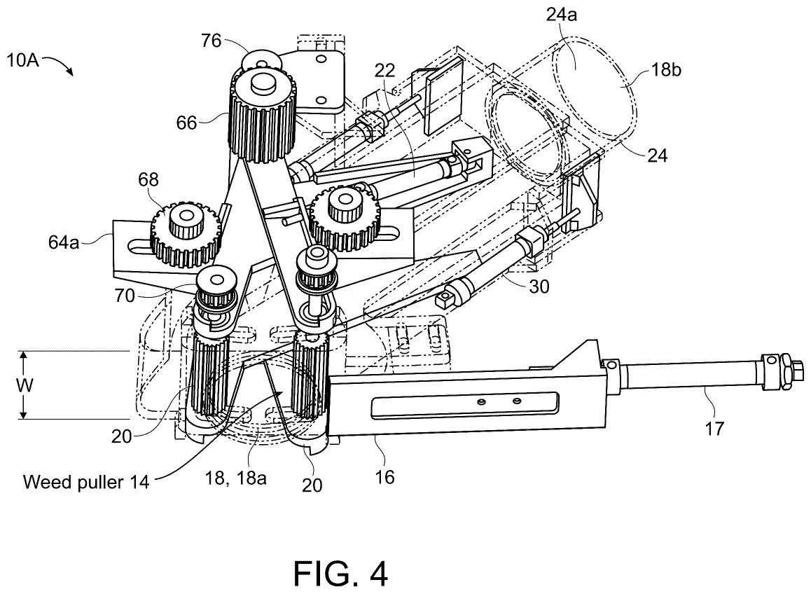

FIG. 4 shows the bottom view of an embodiment of the weeding head 10A. From this view the weed puller roller gears 20 can be seen through the bottom inlet port 18a. In this view, the weed puller assembly 14 is in the open position. When the weed 12 is ready to be extracted, these two roller gears 20 can clamp together around the weed 12 to rotatably pull and extract the weed 12 from the soil 13.

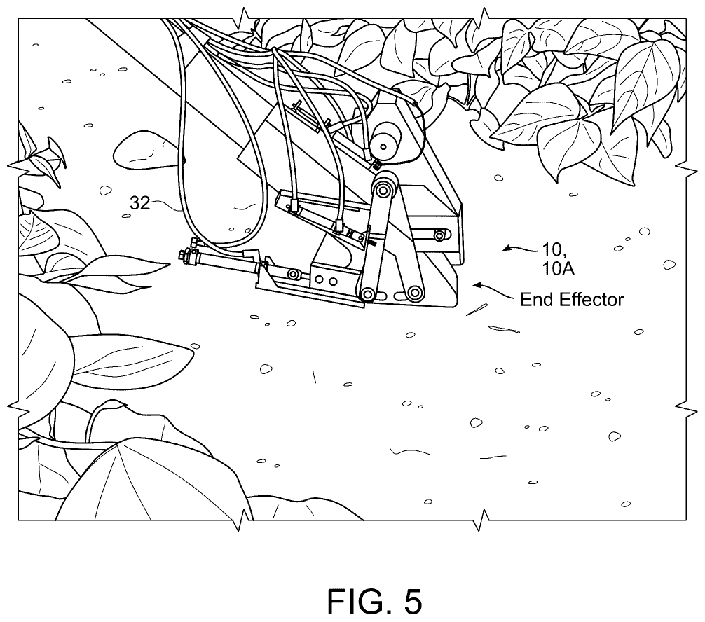

The weeding head 10A can include fabricated parts, modified off-the-shelf components and standard components such as air cylinders, motors and drive components. FIG. 5 shows the weeding head 10A of the weeder 10 in the field. The main housing 18 of the weeding head 10A can be made from plastic such as nylon or Acetal. A series of tubes 32 can supply pressurized air to the pneumatic cylinders 17, 22 and 30 that actuate the root knife 16, weed puller 14 and bypass air ducts 27. Operation can be controlled by the operator 48 via switches at the top of a handle above the weeding head 10A. In some embodiments, the vacuum generator 40, collection container 28 and filter 19 can be carried by a backpack 45 (FIG. 1) worn by the user or operator 48.

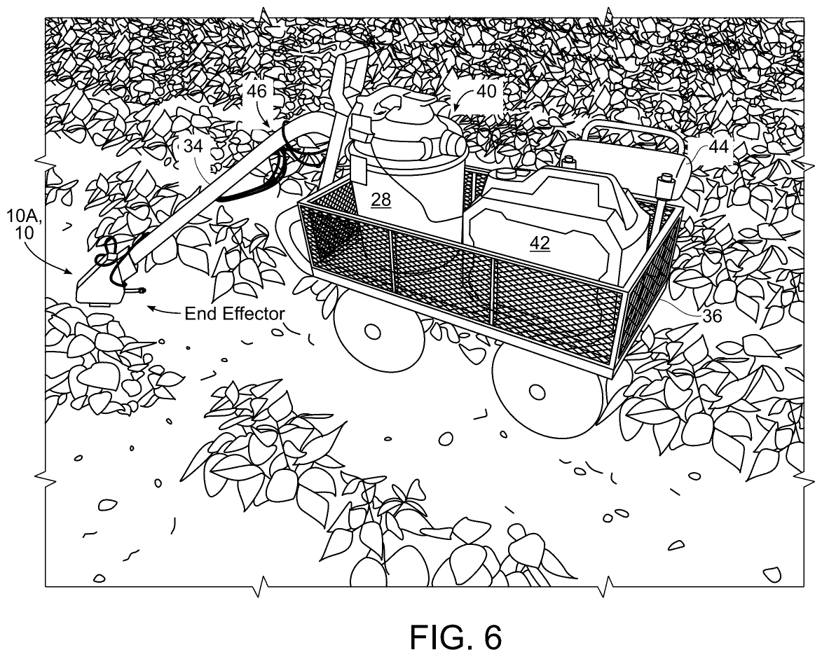

FIG. 6 shows an embodiment of a mobile weeder 10 system, including a weeding head 10A, a vacuum tube 34 attachment handle and a mobile carriage, cart, wagon or platform 36. The weeding head 10A can be attached to the end of a four-foot vacuum tube 34 that can serve as a handle and conduit for the weeds 12 to travel from the weeding head 10A to a connected hose 25 (FIG. 7) and to the collection container 28 on the mobile platform 36. The mobile platform 36 can movably support a vacuum generator 40 having a filter 29, and a weed collection container 28, an electrical generator 42, air compressor 44 and motor controls 46. The mobile platform 36 can have four wheels with two that can be steered so that the operator can pull the system through the field. Embodiments of the mobile platform 36 can operate for eight hours in the field before refueling. Some embodiments can have six or more end effectors or weeding heads 10A, that can be maneuvered automatically, and the mobile platform 36 can be pulled behind a tractor.

Testing of an embodiment of weeder 10 was conducted in commercial agricultural fields with crops and weeds. The weeder 10 was manually operated and powered by a mobile platform 36 that allowed the weeder 10 to be tested eight hours before refueling.

The weeder 10 was tested on all of the weeds 12 encountered in the field. Some of the more prevalent weeds 12 such as purslane, pig weed, and crab grass were encountered. The different types of weeds 12 also required different techniques on how the weeding head 10A engages the weed 12. The pigweed grows vertical with a strong stem, whereas purslane grows horizontally on the ground with several stems emanating from the root. The weeding head 10A can engage pigweed by coming down vertically on the weed 12, whereas the purslane required hovering over the weed 12 and using a circle pattern to collect all of the weed 12 during extraction.

The weeder 10 was tested in the field by a single operator 48, as shown in FIG. 7. The controls 46 for the weeder 10 can be at the top of the vacuum tube/handle 34 and can be operated by the operator's 48 right hand. The operator's 48 left hand can lift the weeding head 10A to help maneuver it. The weight of embodiments of the weeding head 10A can be approximately five pounds.

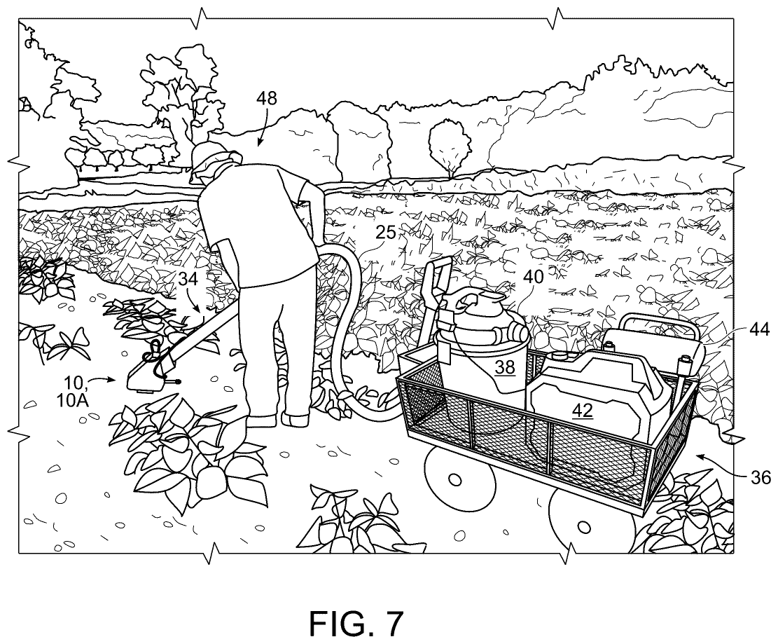

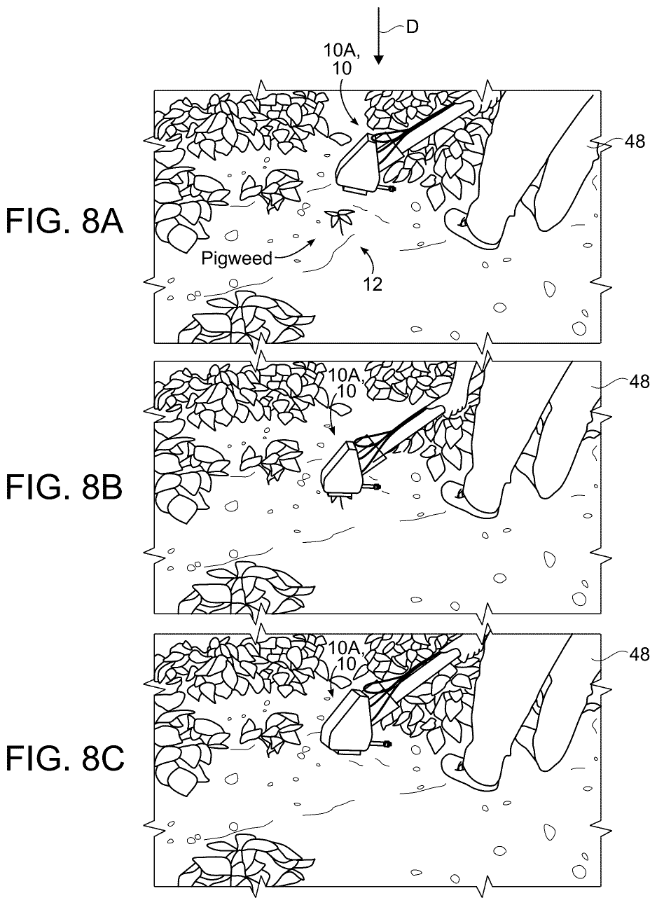

FIGS. 8A-8C shows a sequence of weed 12 extraction where the weed 12 is pigweed, and operator 48 extracts the weed 12 from a bean field. FIG. 8A shows the operator 48 positioning the weeding head 10A above the weed 12, FIG. 8B shows the weeding head 10A engaging the weed 12, and FIG. 8C shows that the weed 12 has been removed from the field.

The weeds 12 that were successfully extracted with the weeder 10 during field testing included the following weeds 12 which are typically seen in commercial fields:
1. Pigweed
2. Night shade
3. Crab grass
4. Purslane
5. Smart weed
6. Red root pigweed
7. Pennsylvania martin
8. Lambs quarter (Roundup™ resistant)

Weeds 12 with a strong and fibrous stem can be extracted without using the root knife or cutting assembly 16, such as pigweed. A fragile and tender weed 12 such as purslane will break above the ground and the root and part of the stem will typically be left behind if the root knife or cutting assembly 16 is not used. Once the root 12a is severed by the root knife or cutting assembly 16 approximately a quarter inch to an inch below the soil 13 surface, the purslane can be extracted with the severed root intact with the rest of the weed 12. Additional testing showed that a rotating disk or saw blade for the root blade or cutting assembly 16 will work better for cutting the purslane root. If the root 12a is not removed, the purslane will grow back. In addition, the mid-to-late-stage purslane weed has approximately 240,000 seeds, removing the purslane from the field is important to reduce unwanted seeding from the weed 12. If the weed 12 is extracted from the soil but left in the field, it will continue to seed.

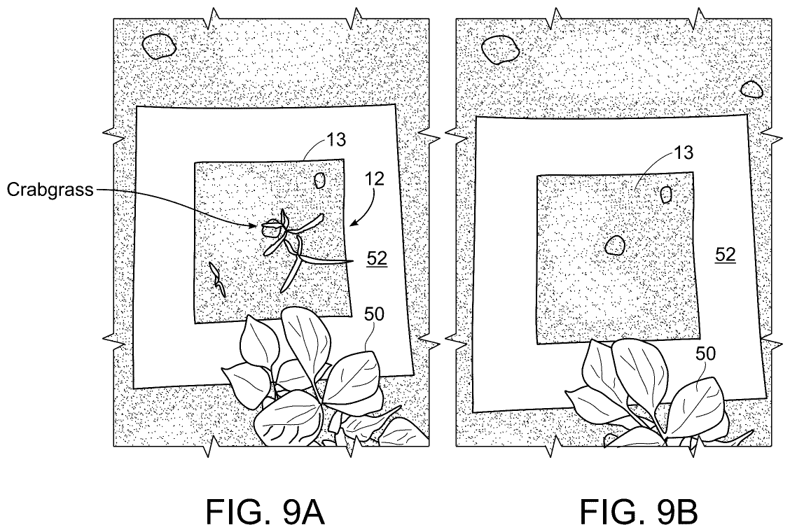

FIGS. 9A and 9B show the results when the weeder 10 was used to extract several crab grass plant weeds 12 growing next to a bean plant 50. A picture frame 52 is positioned around the weeds 12 to emphasize the weeds 12 therein. FIG. 9A shows three crab grass plants or weeds 12 that are in their mid-stage of development. The weeder 10 was used to extract and kill these weeds without using the root knife or cutting assembly 16. FIG. 9B shows weeds 12 removed with minimal disruption to the soil 13 and no damage to the bean plant 50.

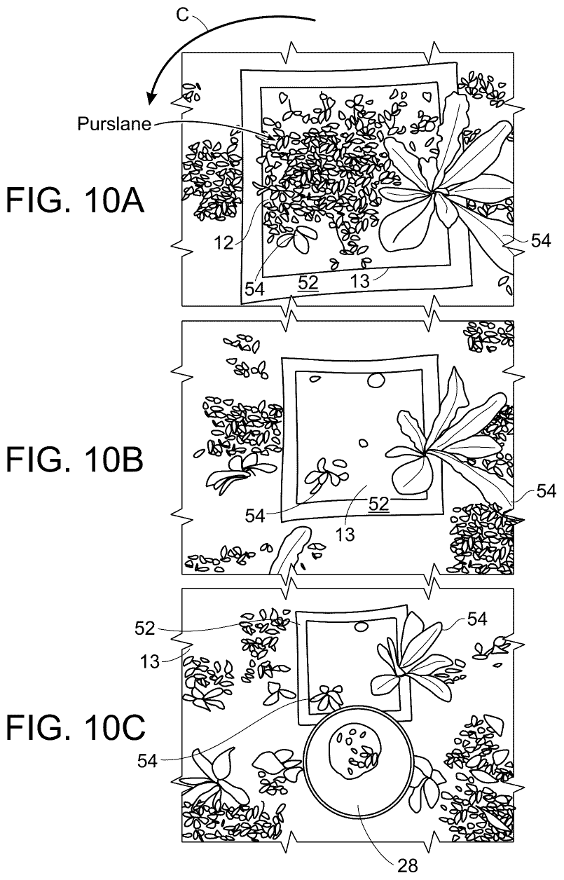

FIG. 10A shows a lacinato kale crop 54 that is infested with the weed 12 purslane. This amount of weed growth will eventually take over the field and reduce the yield from the crop. In FIG. B, the weeder 10 was used to remove the purslane weed 12 from around the crop 54. FIG. 10A shows the weed infestation before the weeder 10 is used. FIG. 10B shows the purslane weeds 12 removed with minimal soil disruption and no damage to the crop 54. The weeding head 10A was maneuvered in a circular pattern indicated by arrow C to collect the purslane weed 12 since it grows horizontally across the ground rather than vertically. FIG. 10C also shows the purslane weeds 12 that were collected in a collection container 28 during extraction. These weeds 12 were carried off the field and disposed of to eliminate possible reseeding in the field, thereby reducing weed growth for the next growing season.

An advantage of the weeder 10 is that it can collect all of the weeds 12 it extracts so that they can be disposed of off the field. At this time the only other option for weed removal in commercial fields is to use manual labor to extract and collect the weeds. The weeder 10 has the capability to extract and remove the weeds 12 from the field.

Embodiments of weeder 10 can operate with six or more end effector weeding heads 10A to automatically remove weeds 12 from the field. The weeding heads 10A can be attached to vision controlled robotic manipulators that can manipulate the weeding heads 10A around the crops.

Referring to FIGS. 2-4 and 11, further description of the weeding head 10A of weeder 10 follows. The weeding head 10A can include a housing 18 that is connected to vacuum tube 34 via top outlet vacuum port 18b along a longitudinal axis 24b. The bottom inlet vacuum port 18a can extend along a longitudinal axis 19 that is at a suitable angle relative to axis 24b, for easier maneuvering or ergonomics over weeds 12, such as 15-75 deg, and in some embodiments 45 deg. As a result, the bottom inlet 18a can be at an angle relative to vacuum tube 34. In some embodiments, bottom inlet 18a can be aligned with axis 24b. The weed pulling assembly 14 can include a linkage assembly 60 having a pivoting twin outer arm or arm member 62, and a pivoting twin inner arm or arm member 64, pivotably mounted to the housing 18 about a lateral pivot axis 66b that is perpendicular to the plane which axes 24b and 19 lie along. As can be seen in FIG. 4, the twin arms 62 and 64 straddle the housing 18 with arm portions extending on opposite sides of housing 18. Each driveable rotary member, gear, roller gear, wheel or roller 20 can be positioned within housing 18 slightly above the bottom of inlet 18a and can be rotatably mounted to the distal end of a respective twin arm 62 and 64 about a drive or driveable axle 70a along an axis 70b that is parallel to axis 66b. The drive axles 70a extend between the arm portions of the twin arms 62 and 64 and laterally through the housing 18 adjacently above the bottom inlet 18a. Opposite sides of the housing 18 can have slots 63 and 65 for allowing the drive axles 70a of both twin arms 62 and 64 extend therethrough so that the arms 62 and 64 can pivot about axis 66b for moving the drive axles 70a and rotary members or rollers 20 towards or away from each other as indicated by the arrows. The slots 63 and 65 can be on opposite sides of axis 19 and can extend in a slight arc about axis 66b. As a result, the rotary members or rollers 20 can be moveably positioned within the housing 18 above the bottom inlet 18a with arms 62 and 64.

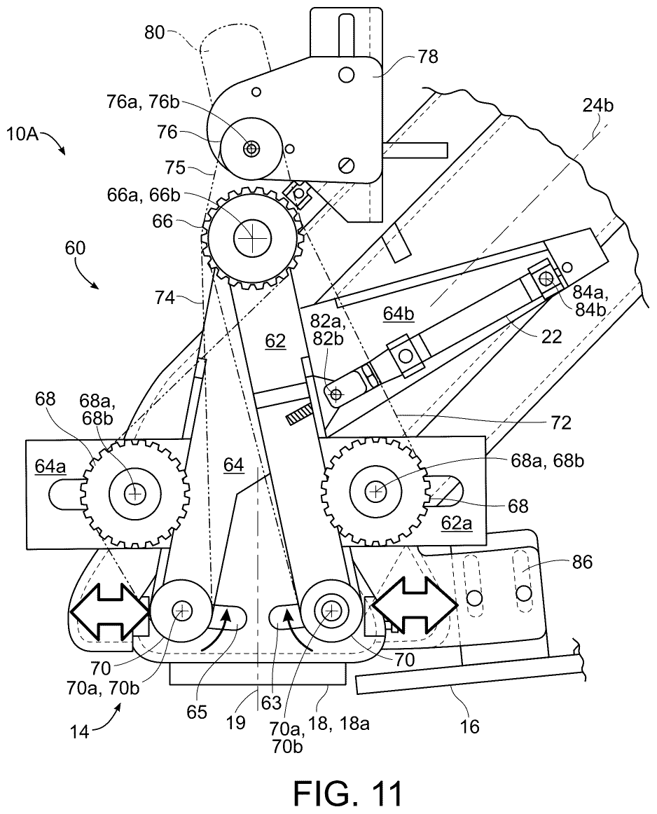

A drive motor bracket 78 can extend from the housing 18 above the linkage assembly 60. An electric drive motor 80 can be mounted to the bracket 78 for driving a rotatable drive pinion, pulley or member 76 about a drive shaft 76a extending along drive axis 76b. The drive axis 76b can be parallel to axis 66b and the drive pulley 76 can drive a rotatable twin drive pinion, pulley or member 66 mounted about axle 66a along axis 66b, with a drive belt 75 extending around pulley 76 and pulley 66. Outer twin arm 62 and inner twin arm 64 can each have an arm half with a respective idler pinion or pulley bracket 62a and 64a, to which a rotatable idler pinion, pulley or member 68 can be rotatably mounted on an axle 68a about an axis 68b. A rotatable roller drive pinion, pulley or member 70 can be rotatably mounted to each drive axle 70a about respective axes 70b for driving rollers 20 rotatably mounted to respective drive axles 70a. An outer arm roller drive belt 72 can extend around and engage the twin drive pinion 66 adjacent to and outside of belt 75, around idler pulley 68 and around roller drive pulley 70 on the outer arm 62, for rotating the roller 20 mounted to the outer arm 62 in the clockwise direction as shown by the arrow in FIG. 11. An inner arm roller drive belt 74 can extend around and engage the twin drive pinion 66 adjacent to and inside of belt 75, around idler pulley 68 and around roller drive pulley 70 on the inner arm 64, with the belt 74 crossing itself below the twin drive pinion 66 for rotating the roller 20 mounted to the inner arm 64 in the opposite rotation direction or counterclockwise as indicated by the arrow in FIG. 11. As a result, when clamped towards each other or together, the rollers 20 can rotatably grip a weed 12 therebetween for pulling the weed 12 upwardly.

The inner arm 64 can have a cylinder bracket 64b extending from each arm half on opposite sides of the housing. A proximal end of a linear actuator such as a pneumatic cylinder 22 can be pivotably mounted to each cylinder bracket 64b of the inner arm 64 about a pivot axle 84a extending along a pivot axis 84b. The distal end of each cylinder 22 can be pivotably mounted to a mid portion of each arm half of the outer arm 62 about a pivot axle 82a extending along a pivot axis 82b. Axes 82b and 84b can be parallel to axes 76b, 66b, 68b and 70b. Actuation of cylinders 22 can move the distal ends of the arms 62/64 and the rollers 20 towards and away from each other along an arc around axis 66b. Extension of the cylinders 22 causes the arms 62/64 to move together for clamping weeds 12 between rollers 20, and contraction of the cylinders 22 causes the arms 62/64 and rollers 20 to move apart from each other. A cutting assembly bracket 86 can extend from housing 18 near bottom inlet 18a for mounting the cutting assembly 16 adjacent to the bottom inlet 18a.

In some embodiments, the housing 18 can an upper length L1 (FIG. 2) extending along axis 24b of about 7 in., and a side length SL of about 4 in. The width W of the housing 18 (FIG. 4) can be about 2½ in. A removable cover 21 (FIG. 2) can enclose the linkage assembly 60 and the combined width of the housing 18 with cover 21 and cutting assembly 16 can be about 6 in. The bottom length LH of the weeding head 10A can be about 6½ in. In some embodiments, when the cutting assembly 16 is a rotary saw blade, the combined bottom length of the weeding head 10A can be about 9 in, allowing the weeding head 10A to be positioned in spaces between crop plants 6-9 in. apart, depending upon the orientation of the weeding head 10A. A lower angled length L2 of the housing 18 extending along axis 19 can be about 2 in. The arm halves of the inner arm 64 can be spaced apart about 2⅝ in., and pivot axis 66b and roller axis 70b extending through the proximal and distal ends of inner arm 64 can be about 5¼ in. apart. Pivot axes 82b on each arm half of inner arm 64 to which the cylinders 22 are mounted can be about 2½ in. away from axis 66b. The arm halves of the inner arm can be about 3/16 in. thick, so that the arm halves of the outer arm 62 can be spaced apart about 3⅛ in. to pivotably fit over the inner arm 64. The pivot axis 66b and roller axis 70b extending through the proximal and distal ends of outer arm 62 can be the same distance apart as for the inner arm 64. Inlet 18a can have an outer diameter of about 2½ in. and an inner diameter of about 2 in. The inner diameter of the inlet 18a can vary, for example from 1 to 6 inches in diameter, depending upon the situation at hand. The bottom of inlet 18a can protrude below housing 18 about ¼ in. The cutting blade of the cutting assembly 16 can be positionable about ¾ in. below the bottom of inlet 18a. Slots 63 and 65 can each be about ¼ in. wide by 1 in. long, separated from each other by about ¼ in., and the centerline of slots 63 and 65 can be spaced from the bottom of inlet 18a by about ¾ in. to position the axles 70a and axes 70b of rollers 20 about ¾ in. above the bottom of inlet 18a. As a result, the bottom surfaces of rollers 20 can be about ½ in. above the bottom of inlet 18a. The rollers 20 can be made of metal such as steel and have an outer surface or circumference with elongate longitudinally extending gear like teeth or protrusions parallel to the longitudinal axis with longitudinal valleys or slots therebetween for clamping and gripping weeds 12 in compression therebetween. The rollers 20 can be about 11/16 in. (0.68 in) diameter and about 2 in. long. When in the open or retracted position, the space between the rollers 20 can be about 1¼ in. In some embodiments, the rollers 20 can have other suitable gripping or frictional surfaces, such as knurls, spikes or spaced blunt protrusions.

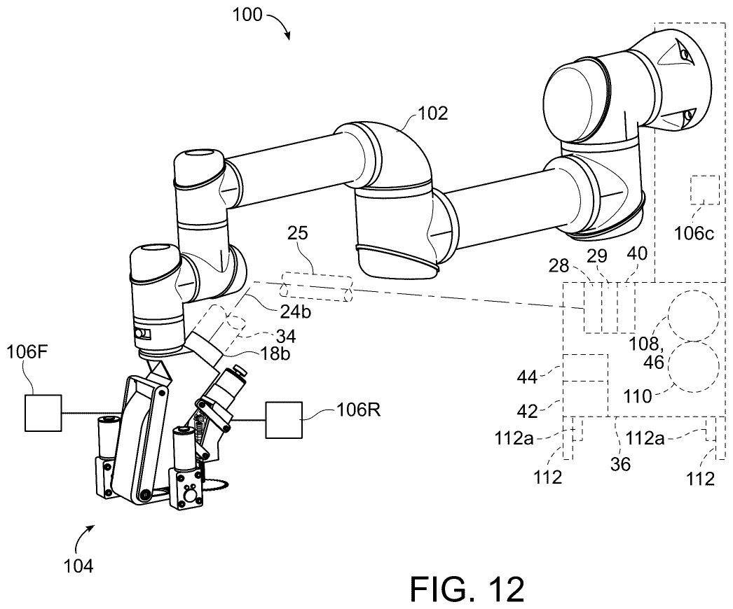

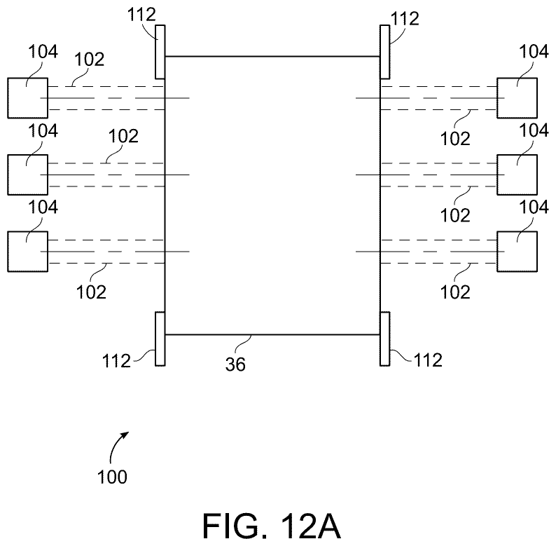

Referring to FIGS. 12 and 12A, weeder 100 is another embodiment of a weeding apparatus, device, precision weeder, or weeder in the present disclosure, in which a weeding head 104 can be mounted to the distal end of a robotic arm 102. The robotic arm 102 can be mounted to a carriage 36 that is controllably movable with a set of driveable wheels 112 powered by motors 112a. In some embodiments, the robotic arm 102 can be a five axis robot arm for moving the weeding head 104 with precision to pull weeds 12 as a precision weeder. The carriage 36 can house a weed collection chamber, bin, container or receptacle 28 with a filter 29, a vacuum generator or device 40, an electrical generator 42, an air compressor 44, a carriage vision camera or system 106C, and a controller 108 with motor controls 46 and memory 110. The outlet 18b of the weeding head 104 can be in vacuum communication with the weed receptacle 28 via tube 34 and/or hose 25 for conveying pulled weeds 12 from the weeding head 104 into the weed receptacle 28 on the carriage 36. The controller 108 can be in communication with the robotic arm 102, the weeding head 104 (including motors, actuators and sensors), vacuum generator 40, electrical generator 42, air compressor 44, carriage vision system 106C, as well as front facing head vision camera or system 106F and rear facing head vision camera or system 106F for controlling operation and movement of the weeder 100. Communication can be wireless, or by wired lines. In some embodiments, more than one robotic arm 102 can be mounted to the carriage 36, for example six, as shown in FIG. 12A. In such an embodiment, the carriage 36 can travel down rows of an agricultural crop field and pull multiple weeds 12 simultaneously.

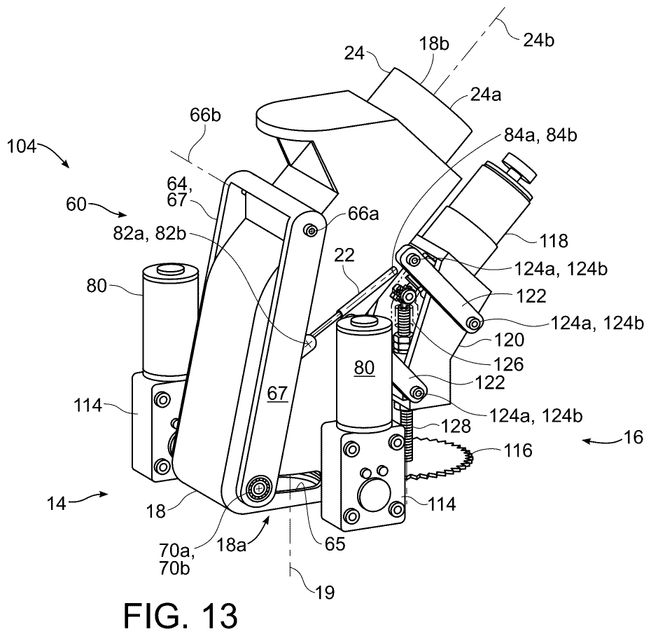

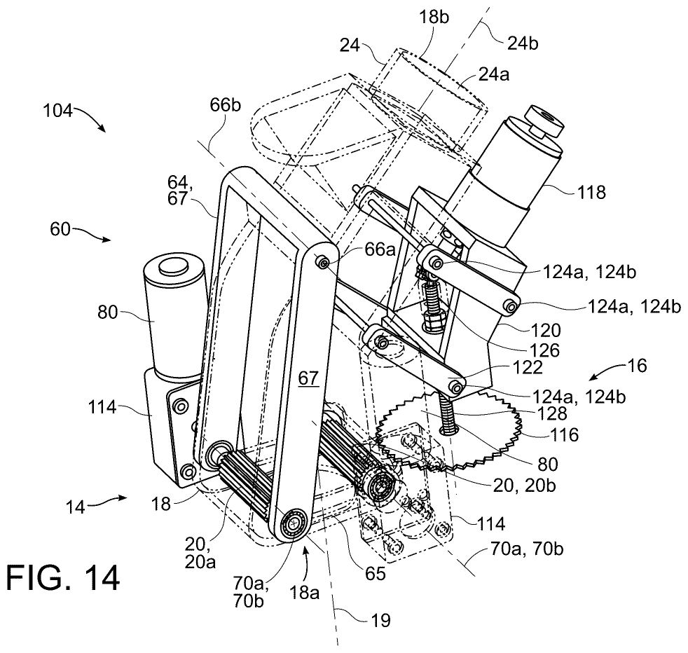

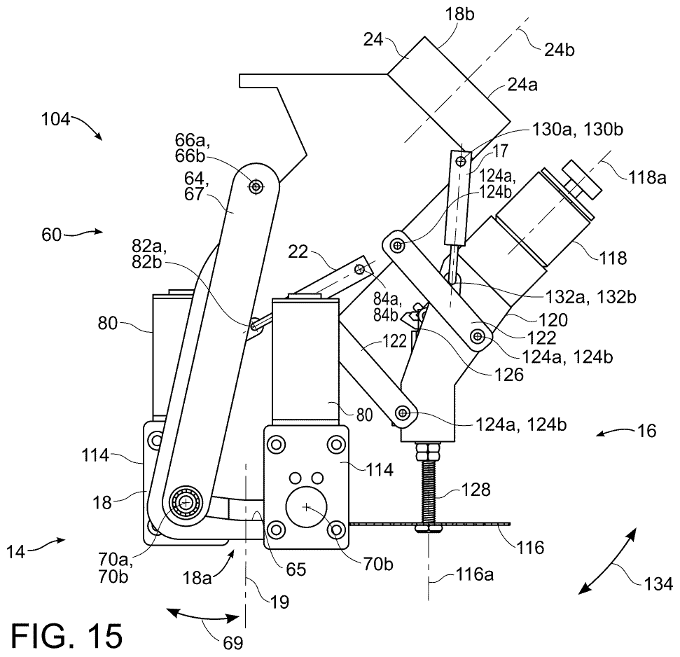

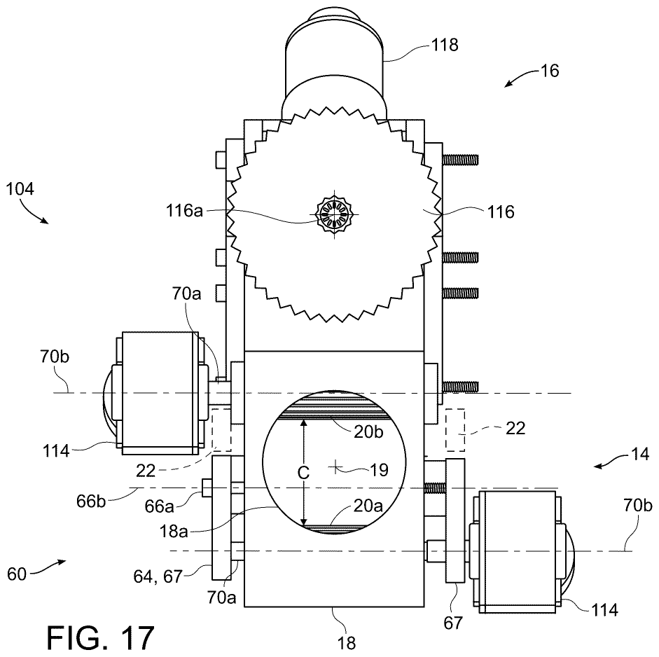

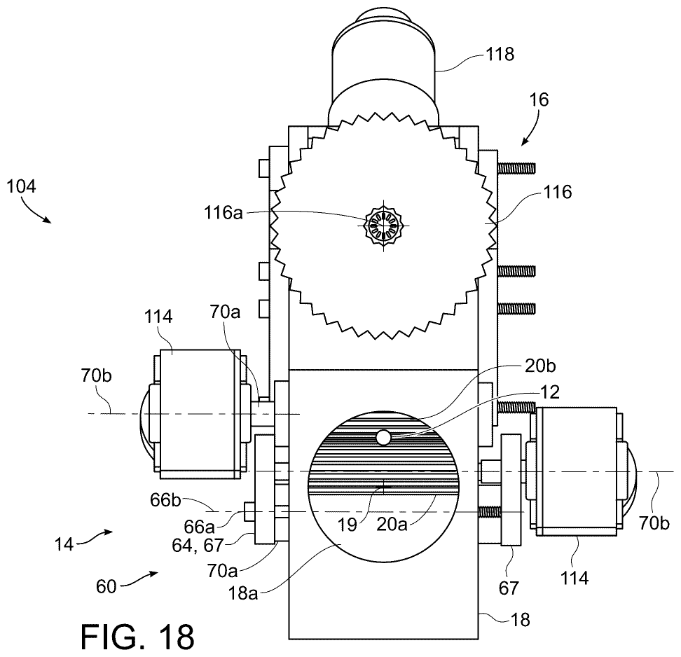

Referring to FIGS. 13-18, weeding head 104 is another embodiment of a weeding head that differs from weeding head 10A in that the linkage assembly 60 and weed puller or weed pulling assembly 14 only has one twin arm or arm member 64, with a first driven gripping rotary member, gear, roller gear, wheel or roller 20a positioned within housing 18 above the bottom of inlet 18a and rotatably mounted to the arm member 64 by a drive or driveable axle 70a along an axis 70b. The arm member 64 can be pivotably mounted to the housing 18 by axle 66a along axis 66b. The second driven gripping rotary member, gear, roller gear, wheel or roller 20b can be rotatably mounted within the housing 18 above the bottom of inlet 18a by a drive or driveable axle 70a along an axis 70b that is at a fixed location. Roller 20a can be a roller 20 that is moveable or translatable laterally or sideways relative to its axis 70b, and roller 20b can be a roller 20 that is in a fixed position. Each roller 20 can be controllably driven by a motor 80 and gear box or transmission 114. One motor 80 and transmission 114 can be mounted to one arm half 67 of arm member 64 along an axis 70b for driving axle 70a and the pivotably laterally moveable roller 20a. The other motor 80 and transmission 114 can be mounted to the side of housing 18 along a second axis 70b for driving the axle 70b and the roller 20b which are at a fixed position. The axle 70a of arm member 64 can extend through a single slot 65 through opposite sides of the housing 18 to allow the arm member 64 and roller 20a to pivot, rotate or swing about axis 66b in an arc for moving the roller 20a and its drive axle 70a within housing 18 towards and away from roller 20b and its drive axle 70a as indicated by arrows 69 in FIG. 15, from the open position O in FIG. 17, to the closed position in FIG. 18 where the perimeters or outer diameters of rollers 20a and 20b are close to or in contact with, or in engagement with each other for gripping a weed 12. As a result, the rollers 20a and 20b can be moved towards and away from each other, or relative to each other by moving only roller 20a with arm member 64. Two linear actuator or pneumatic cylinders 22 can be pivotably connected to opposite sides of housing 18 and to a mid portion of each arm half 67 of arm member 64, via axles 82a and 84a, along respective axes 82b and 84b, for actuating arm member 64. The bottom inlet 18a can be flush with the bottom surface of housing 18.

The root cutting assembly 16 can have a rotatable saw blade or member 116 that is controllably rotatable by shaft 128 extending from bracket 120 about a generally upright axis 116a. The shaft 128 can be rotated by a motor 118 via a jointed drive shaft 126 that can transmit power from the motor 118 to the shaft 128 where motor 118 extends along an axis 118a that is at an angle to axis 116a. The bracket 120 can be moveably mounted to the housing with two spaced apart links or bars 122 by pivot axles 124a along axes 124b, forming a four bar linkage. Referring to FIG. 15, a linear actuator or pneumatic cylinder 17 can be pivotably mounted between housing 18 and the upper bar 122 via pivot axles 130a and 132a along respective axes 130b and 132b. The cylinder 17 can move the saw blade 116 slightly downwardly and under inlet 18a in an arc as indicated by arrows 134 for cutting roots 12a, for example, about 1 to ¼ in. below the surface of the soil 13. Features and components of the weeding head 104 that are the same or similar to that of weeding head 10A can have similar dimensions.

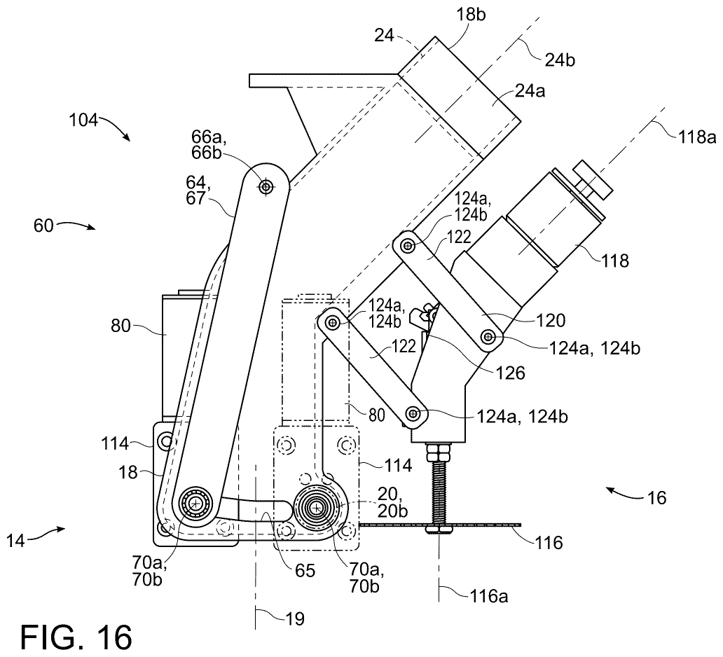

In use, referring to FIGS. 16 and 17, when a weed 12 is identified to be weeded, pulled or picked, with the roller 20a positioned in the open position O relative to roller 20b by arm member 64, and the saw blade 116 pulled back in the retracted position, the weeding head 104 is brought down over the weed 12 with the vacuum device 40 activated for forming suction into bottom vacuum inlet port 18a. The vacuum suction pulls the weed 12 into the inlet 18a, into the space between rollers 20a and 20b, and can extend upwardly into the inlet 18a above or downstream from the rollers 20a and 20b within the vacuum port. Having the roller 20a in the open position O allows maximum vacuum or suction to be applied to the weed 12 through the inlet 18a and between the rollers 20a and 20b. As seen in FIG. 17, less than half the diameter of the fixed position roller 20b extends into or across the inlet 18a, for example less than 40%, such as about 38%. In addition, when in the open position O, only a small portion of the diameter of the moveable roller 20a extends into or across the inlet 18a on the opposite side, for example about 16%. As a result, when in the open position O, the rollers 20a and 20b extend across only about 25% of the opening of inlet 18a. Therefore, about 75% of the opening of inlet 18a is unobstructed and can provide a clear straight path for suction into the inlet 18a and into the vacuum port. The rollers 20a and 20b can be rotating during suction of the weed 12 which can aid in drawing the weed 12 further into the inlet 18a and vacuum port. Even when in the open position O, having portions of the rollers 20a and 20b extending along opposite sides or edges of the inlet port 18a can help guide upper stem and leaf portions of the weed 12 therebetween and into the vacuum port by engaged contact rotation of rollers 20a and 20b with such upper portions from opposite sides. As a result, the rotating rollers 20a and 20b when in the open position O can act as vacuum port inlet guides. Depending upon the type of weed 12, the movement of the weeding head 104 can differ for suctioning the weed 12 into the inlet 18a. For example, referring to FIG. 8A, when the weed 12 is a generally upright weed 12 such as pigweed, the weeding head 104 can be moved generally vertically downwardly over the weed 12 to suction the weed 12 into the inlet 18a as indicated by arrow D. Referring to FIG. 10A, when the weed 12 is a low laterally spreading ground cover or carpet weed such as purslane, the weeding head 104 can be first moved down towards the weed 12 and then moved in a generally circular pattern around the weed 12 as indicated by arrow C to suction the laterally extending perimeter edges of the weed 12 into the inlet 18a. Typically once a weed 12 is suctioned into the inlet 18a, the bottom of the weeding head 104 can be positioned on the soil 13 so that the rollers 20a and 20b can be positioned within about 1 in. above the soil 13 for engaging or clamping the base of the stem of the weed 12 at a location that is strong. The small size of the weeding head 104 can allow weeding in small spaces between crop plants.

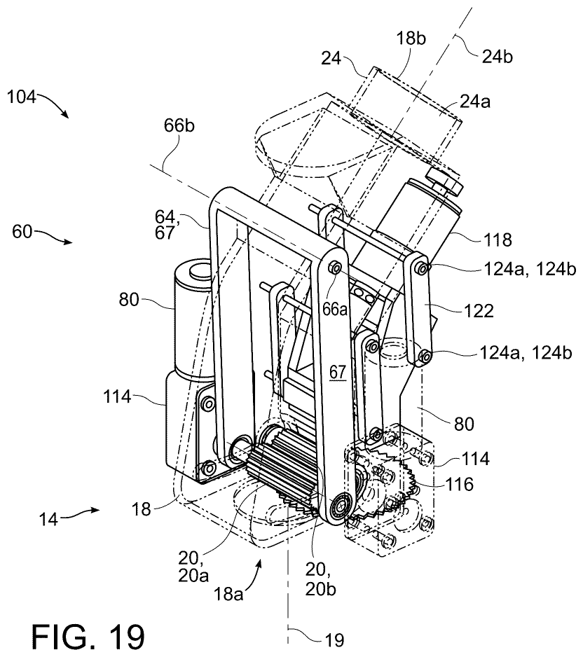

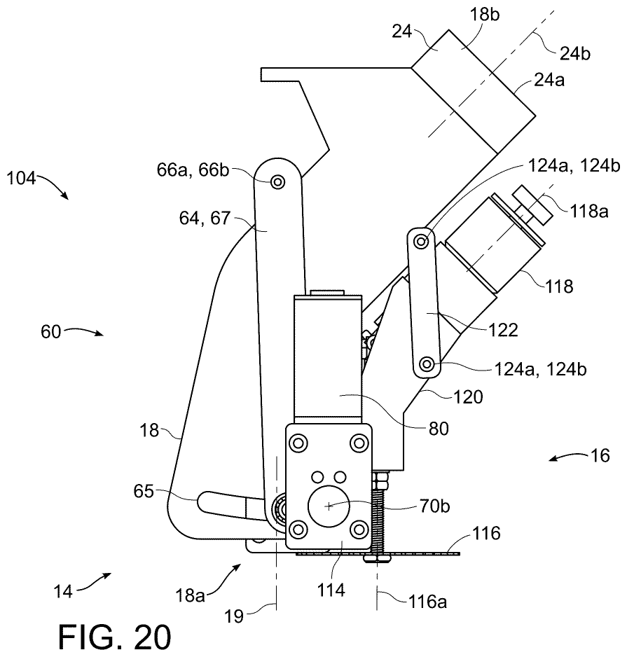

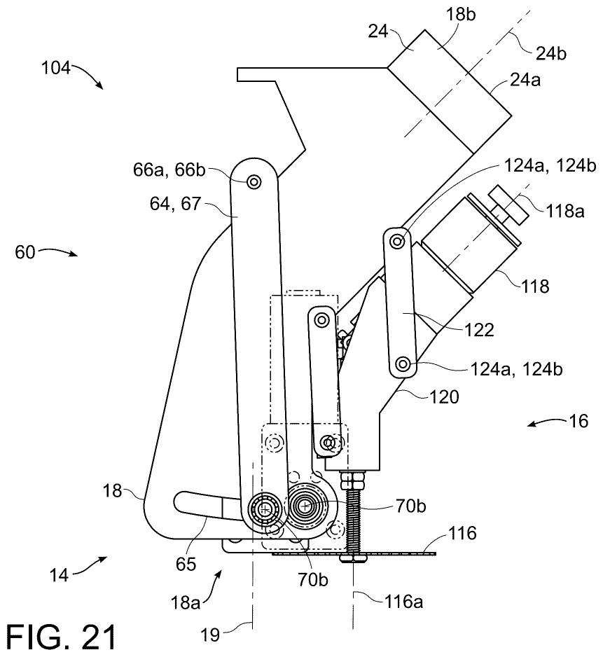

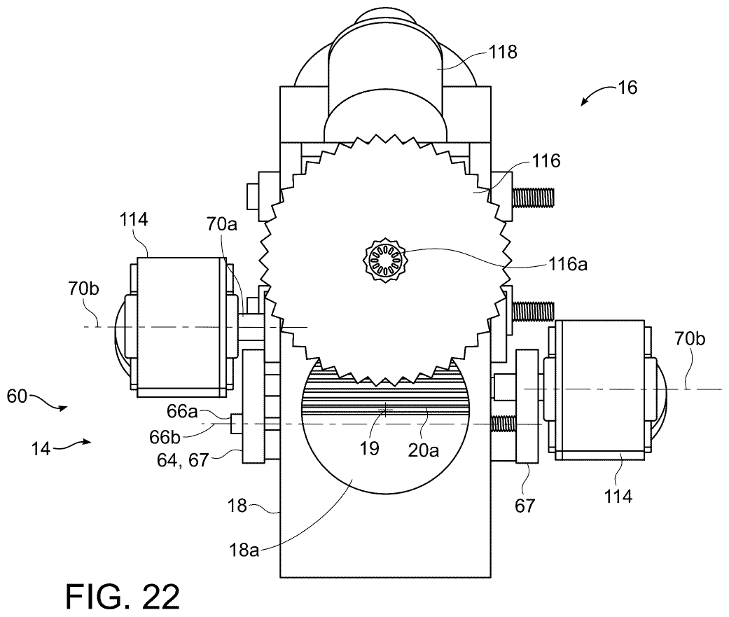

Referring to FIG. 18, the arm member 64 can be activated by cylinders 22 to move, rotate, swing or pivot the moveable roller 20a laterally or sideways relative to its axis 70b towards fixed position roller 20b and clamp the stem of the weed 12 therebetween where upward rotation of the contacting inner facing surfaces of the rollers 20a and 20b on the stem of the weed 12 can engage, grip and pull the weed 12 from the soil 13. The vacuum suction of the vacuum device 40 causes the pulled weed 12 to travel downstream from the inlet 18a through the vacuum port and duct 24, out the outlet 18b of the weeding head 104, through the tube 34 and hose 25 into the weed receptacle 28 for storage. The filter 29 in the weed receptacle 28 can prevent seeds from the weeds 12 to escape back into the agricultural field, thereby reducing the amount of weeds that can germinate in the next growing season. If the weed 12 has a strong stem, the cutting assembly 16 is not required to be used for cutting the roots 12a of the weed 12. About 80% of weeds in agricultural fields can be pulled with only rollers 20a and 20b. However, if the stem of the weed 12 is weak or fragile such as purslane where the stem will break when pulled only by rollers 20a and 20b, and regrowth of the weed 12 is likely, the cutting assembly 16 needs to be used. As a result, the motor 118 of the cutting assembly 16 can be activated for rotating the rotary saw or cutting blade 116, and the cylinder 17 can be activated for moving the saw blade 116 downwardly into the soil 13 and forwardly across at least a portion of the inlet 18a along an arc 134 for cutting the roots 12a of the weed 12 so that the majority of the weed 12 can be pulled to prevent regrowth. FIGS. 19-22 show the saw blade 116 moved into cutting position below and across a portion of the inlet 18a, between the two transmissions 114 of the rollers 20a and 20b. In some embodiments, the rollers 20a and 20b do not have to be rotated and vacuum does not need to draw suction through inlet 18a until weed pulling is desired, for example, while the weeder 100 is merely being repositioned. The small size of the weeding head 104 allows weeds 12 close to crop plants to be pulled with minimal disruption of the soil 13.

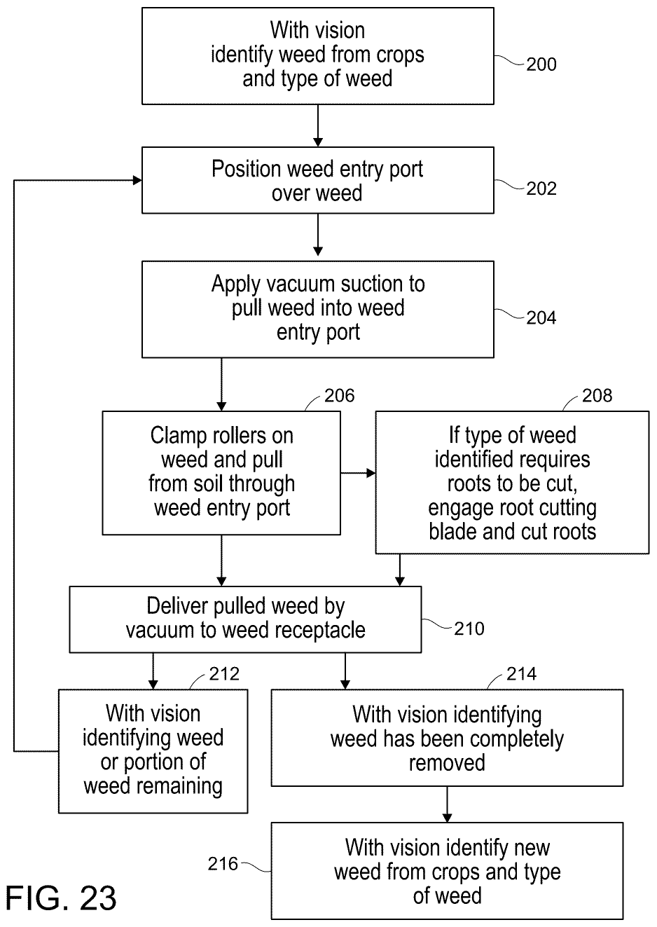

Referring to FIGS. 12, 12A and 23, further description of operation follows. The weeder 100 can be operated automatically by controller 108, and the carriage 36 can be driven through an agricultural field by wheels, guided by carriage vision system 106C. The carriage vision system 106C and/or front facing head vision system 106F can identify a weed 12 from crops, and the type of weed 12 in step 200 (FIG. 23). The type of the weed 12 can be identified by comparison with a stored database of weed types and characteristics within memory 110. In some circumstances, the controller 108 and/or memory 110 can also be programmed to consider diseased crop plants or debris as weeds for removal, which can be desirable for leafy greens or salad crops prior to harvest. Once the weed 12 is identified the carriage 36 and/or robotic arm 102 can be moved to position the bottom inlet or weed entry port 18a over the weed 12 in step 202. In addition, the proximity, location and space between crop plants can also determine the approach path of the weeding head 104 where the controller 108 can make a determination based on what the vision systems 106C and/or 106F see. Vacuum suction is then applied to pull the weed 12 into the inlet 18a in step 204. The type of weed 12 can determine the path of the weeding head 104 during suction, such as moving downward (arrow D in FIG. 8A) for pigweed, and moving first downward and then in a generally circular pattern (arrow C in FIG. 10A) for purslane. The rollers 20a and 20b are then clamped on the weed 12 and the weed 12 is pulled through the inlet 18a by frictional engagement, meshing or gripping rotation of the clamping rollers 20a and 20b in step 206. If the type of weed 12 that is identified requires the roots 12a to be cut, the cutting assembly 16 is activated for cutting the roots 12a in step 208. Once the weed 12 is pulled, the vacuum conveys the pulled weed 12 out from the weeding head 104 through tube 34 and hose 25 into the weed receptacle 28 in step 210. The filter 29 can retain the seeds of the weed 12 within weed receptacle 28. After the weeding head 104 is raised and/or moved forward, the rear facing head vision system 106R can view the location from which weed 12 was pulled to either identify whether the weed 12 or portions thereof still remain in step 212, or identify whether the weed 12 has been completely removed in step 214. If the weed 12 or portions thereof still remain, then step 202 is repeated where the inlet 18a is repositioned over the weed 12. If the weed 12 has been identified as completely removed, the vision systems 106C and/or 106F identify a new weed 12 from the crops and type of weed 12, and the process repeats. In the embodiment of FIG. 12A, the weeder 100 can have six weeding heads 104 simultaneously moved by six respective robotic arms 102 for simultaneously identifying and pulling weeds 12 in a field. Data on each weed 12 pulled can be saved into memory, such as type, size, location in the field, etc. for producing reports that can be helpful for management of the agricultural field. In some embodiments, weeder 100 can use control software with AI control. In addition to the vision system locating and identifying weeds 12 from the crops, the optimal path for the robotic arm 102 and the weeding head 104 can be plotted to remove the weeds 12 without damaging the crops. Machine learning can be incorporated to learn from past attempts to remove the weeds 12, and determine the best technique to remove the weeds 12. Examples can include when to activate the vacuum, using straight or circular approach paths of the weeding head 104, when and where to clamp the weeds 12, etc.

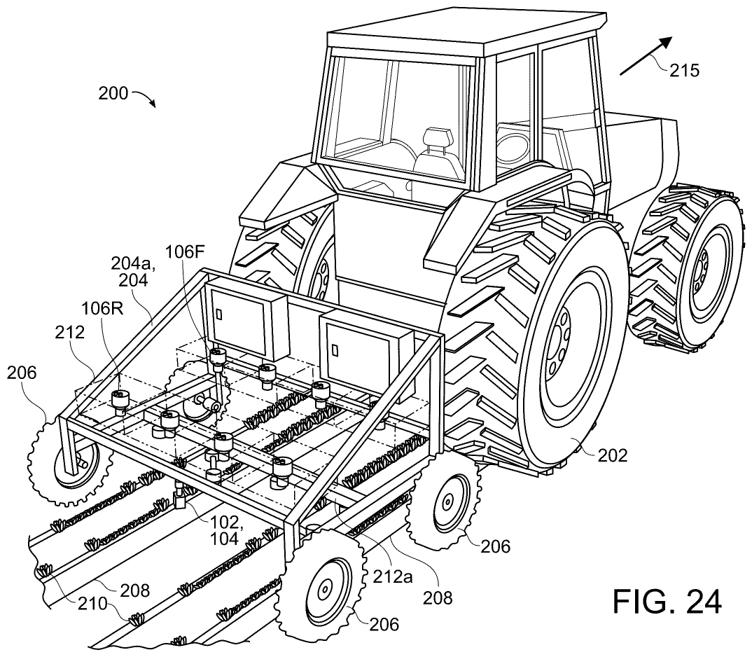

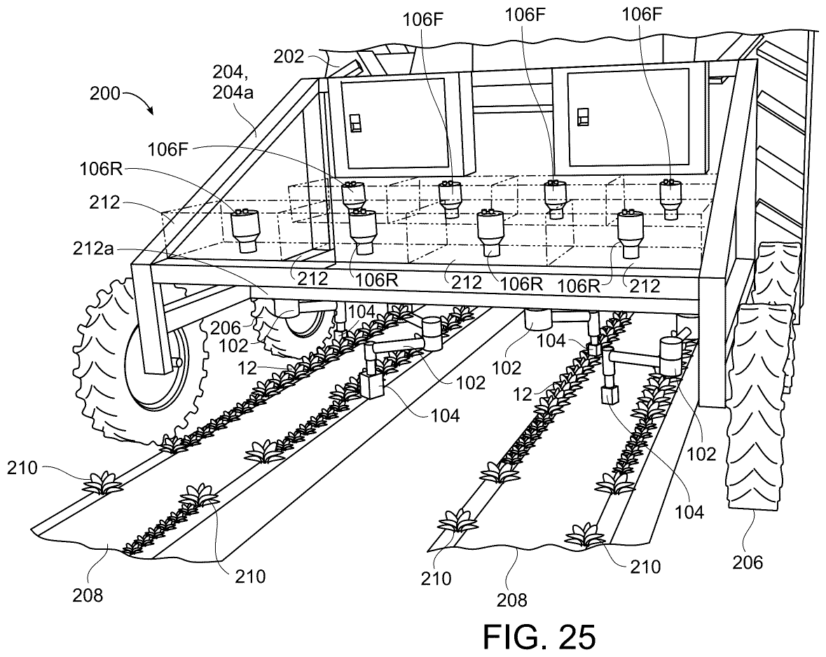

Referring to FIGS. 24 and 25, weeding apparatus, device, precision weeder or weeder 200 is another embodiment of a weeder in the present disclosure. Weeder 200 can include a tractor 202 connected to a mobile carriage, cart, wagon or platform 204, for pulling the carriage 204 over elongate row beds 208 of crops or crop plants 210. The tractor 202 can be manually driven by an operator, or can be guided with a vision system 106C, and controller 108 with motor controls 46 and memory 110 (FIG. 12). The carriage 204 can have frame 204a with wheels 206 rotatably mounted thereto for moveably supporting the carriage 36. A series of weeding blocks or modules 212 can be mounted to the frame 204a of the carriage 204. Each weeding module 212 can include a frame, structure or base 212a to which a robotic arm 102 and weeding head 104 is moveably mounted and in communication with controller 108, between a front facing camera or vision system 106F and a rear facing camera or vision system 106R. FIGS. 24 and 25 depict one lateral row of four side by side modules 212 on the carriage 204 extending along the lateral direction, perpendicular to the direction of travel 215. The modules 212 are shown being used to pull weeds 12 between rows of crops 210 on two parallel elongate row beds 208. Each row bed 208 can include two rows of crops 210, so that two weeding heads 104 are shown pulling weeds 12 from each row bed 208. In some embodiments, the carriage 204 can straddle an 80 inch distance over row beds 208. The robotic arm 102 can have 3, 4, 5, or 6 degrees of freedom, depending upon the situation at hand. The modules 212 can include the front facing vision systems 106F for identifying and engaging the weeds 12, and the rear facing vision systems 106R for determining if the weeds 12 are removed.

While example embodiments have been particularly shown and described, it will be understood by those skilled in the art that various changes in form and details may be made therein without departing from the scope of the embodiments encompassed by the appended claims. For example, various features of the different embodiments in the present disclosure can be combined together and/or omitted. Although some dimensions have been described, the dimensions can vary depending upon the situation at hand. In addition to use in agricultural fields, the weeders described can be used in nonagricultural environments, including beaches, highways and airport runways.

What is claimed is:

1. A weeding apparatus comprising:
a duct having a vacuum port for suctioning by vacuum at least a portion of a weed into the vacuum port; and
a weed pulling assembly positioned within the vacuum port for pulling the weed through the vacuum port in a downstream direction, the weed pulling assembly comprising two opposing weed pulling driveable rotary members for clamping and rotatably pulling the weed therebetween, the two driveable rotary members being moveable relative to each other between a spaced apart position for allowing the weed to be suctioned therebetween, and a position for contacting and rotatably pulling the weed, each driveable rotary member being rotatably mounted about a respective rotatable driveable axle, the driveable axles being moveable relative to each other towards and away from each other.

2. The weeding apparatus of claim 1 in which the weed pulling assembly further comprises a linkage assembly to which at least one of the driveable axles is rotatably mounted, the linkage assembly for moving the two driveable rotary members towards and away from each other.

3. The weeding apparatus of claim 2 in which the linkage assembly comprises a pivoting arm having proximal and distal ends, the pivoting arm being pivotable about a pivot joint at the proximal end, one driveable axle being rotatably mounted to the distal end, the pivoting arm being pivotably moveable by an actuator.

4. The weeding apparatus of claim 3 further comprising a cutting assembly mounted adjacent to the vacuum port for cutting roots of the weed.

5. The weeding apparatus of claim 4 in which the cutting assembly comprises a rotary saw blade.

6. The weeding apparatus of claim 1 further comprising a vacuum device in communication with a weed receptacle that is connected to the vacuum port by a vacuum conduit, for conveying the pulled weed from the vacuum port by vacuum through the vacuum conduit into the weed receptacle for storing the pulled weed.

7. The weeding apparatus of claim 6 further comprising a vacuum diverter positioned downstream from the weed pulling assembly for controllably diverting vacuum from the vacuum port to a position downstream from the weed pulling assembly.

8. The weeding apparatus of claim 7 further comprising a filter associated with the weed receptacle for retaining seeds from the pulled weed in the weed receptacle.

9. The weeding apparatus of claim 6 further comprising a backpack for carrying the vacuum device and the weed receptacle when worn by a user.

10. The weeding apparatus of claim 6 further comprising a movable carriage in which the vacuum device and the weed receptacle are conveyed.

11. The weeding apparatus of claim 10 in which the vacuum port with the weed pulling assembly is connected to a movable robotic arm mounted to the movable carriage.

12. The weeding apparatus of claim 11 further comprising a controller for controlling operation of the weeding apparatus.

13. The weeding apparatus of claim 12 further comprising a vision system for guiding positioning of the robotic arm and the vacuum port.

14. The weeding apparatus of claim 13 further comprising at least two robotic arms mounted to the movable carriage, each robotic arm being connected to a respective vacuum port with a weed pulling assembly.

15. The weeding apparatus of claim 1 further comprising a housing including the duct, the vacuum port having a weed entry port and a weed exit port, with a flow path therebetween, the weed entry port and the weed exit port having dimensions that enable suctioning by vacuum through the flow path.

16. The weeding apparatus of claim 15 in which the weed pulling assembly is positioned in fluid communication with the weed entry port and the weed exit port, the weed pulling assembly configured to apply a mechanical pulling force to the at least a portion of the weed drawn into the weed entry port of the vacuum port, and to release the weed into the flow path toward the weed exit port.

17. A weeding apparatus comprising:
a duct having a vacuum port for suctioning by vacuum at least a portion of a weed into the vacuum port;
a weed pulling assembly positioned within the vacuum port for pulling the weed through the vacuum port in a downstream direction, the weed pulling assembly comprising two opposing weed pulling driveable rotary members for clamping and rotatably pulling the weed therebetween, the two driveable rotary members being moveable relative to each other between a spaced apart position for allowing the weed to be suctioned therebetween, and a position for contacting and rotatably pulling the weed, each driveable rotary member being rotatably mounted about a respective rotatable driveable axle, the driveable axles being rotatably mounted to a linkage assembly, the linkage assembly for moving the two driveable rotary members relative to each other towards and away from each other;
a vacuum device in communication with a weed receptacle that is connected to the vacuum port by a vacuum conduit, for conveying the pulled weed from the vacuum port by vacuum through the vacuum conduit into the weed receptacle for storing the pulled weed; and
a backpack for carrying the vacuum device and the weed receptacle when worn by a user.

18. The weeding apparatus of claim 17 further comprising a cutting assembly comprising a rotary saw blade mounted adjacent to the vacuum port for cutting roots of the weed.

19. A weeding apparatus comprising:
a movable carriage;
a robotic arm mounted to the movable carriage;
a duct having a vacuum port mounted to the robotic arm for suctioning by vacuum at least a portion of a weed into the vacuum port, a weed pulling assembly positioned within the vacuum port for pulling the weed through the vacuum port in a downstream direction, the weed pulling assembly comprising two opposing weed pulling driveable rotary members for clamping and rotatably pulling the weed therebetween, the two driveable rotary members being moveable relative to each other between a spaced apart position for allowing the weed to be suctioned therebetween, and a position for contacting and rotatably pulling the weed, each driveable rotary member being rotatably mounted about a respective rotatable driveable axle, the driveable axles being moveable relative to each other towards and away from each other;
a vacuum device in communication with a weed receptacle that is connected to the vacuum port by a vacuum conduit, for conveying the pulled weed from the vacuum port by vacuum through the vacuum conduit into the weed receptacle for storing the pulled weed;
a controller for controlling operation of the weeding apparatus; and
a vision system for guiding positioning of the robotic arm and the vacuum port.

20. The weeding apparatus of claim 19 further comprising a cutting assembly mounted adjacent to the vacuum port for cutting roots of the weed, the cutting assembly comprising a rotary saw blade.

21. The weeding apparatus of claim 20 further comprising at least two robotic arms mounted to the movable carriage, each robotic arm being connected to a respective vacuum port with a weed pulling assembly and a cutting assembly.

22. The weeding apparatus of claim 21 in which the weed pulling assembly further comprises a linkage assembly to which at least one of the driveable axles is rotatably mounted, the linkage assembly for moving the two driveable rotary members towards and away from each other.

23. A method of removing weeds with a weeding apparatus comprising:
positioning a duct having a vacuum port over a weed within soil;
suctioning at least a portion of the weed into the vacuum port by vacuum;
with a weed pulling assembly positioned within the vacuum port comprising two opposing weed pulling driveable rotary members, clamping the weed between the two drivable rotary members and rotating with the weed clamped therebetween for pulling the weed from the soil and through the vacuum port in a downstream direction, the two driveable rotary members being moveable relative to each other between a spaced apart position for allowing the weed to be suctioned therebetween, and a position for contacting and rotatably pulling the weed, each driveable rotary member being rotatably mounted about a respective rotatable driveable axle, the driveable axles being moveable relative to each other towards and away from each other.

24. The method of claim 23 in which the weed pulling assembly comprises a linkage assembly to which at least one of the driveable axles is rotatably mounted, the method further comprising moving the two driveable rotary members towards each other with the linkage assembly.

25. The method of claim 24 in which the linkage assembly comprises a pivoting arm having proximal and distal ends, the pivoting arm being pivotable about a pivot joint at the proximal end, one driveable axle being rotatably mounted to the distal end, the method further comprising pivotably moving the pivoting arm with an actuator.

26. The method of claim 25 further comprising cutting roots of the weed with a cutting assembly mounted adjacent to the vacuum port.

27. The method of claim 26 in which the cutting assembly comprises a rotary saw blade.

28. The method of claim 23 in which the weeding apparatus further comprises a vacuum device in communication with a weed receptacle that is connected to the vacuum port by a vacuum conduit, the method further comprising conveying the pulled weed from the vacuum port by vacuum through the vacuum conduit into the weed receptacle for storing the pulled weed.

29. The method of claim 28 further comprising controllably diverting vacuum from the vacuum port to a position downstream from the weed pulling assembly with a vacuum diverter positioned downstream from the weed pulling assembly.

30. The method of claim 29 further comprising retaining seeds from the pulled weed in the weed receptacle with a filter associated with the weed receptacle.

31. The method of claim 28 further comprising carrying the vacuum device and weed receptacle with a backpack worn by a user.

32. The method of claim 28 further comprising conveying the vacuum device and the weed receptacle in a movable carriage.

33. The method of claim 32 in which the vacuum port with the weed pulling assembly is connected to a movable robotic arm mounted to the movable carriage, the method further comprising positioning the vacuum port over selected weeds with the robotic arm.

34. The method of claim 33 further comprising controlling operation of the weeding apparatus with a controller.

35. The method of claim 34 further comprising guiding positioning of the robotic arm and vacuum port with a vision system.

36. The method of claim 35 in which at least two robotic arms are mounted to the movable carriage, each robotic arm being connected to a respective vacuum port with a weed pulling assembly, the method further comprising simultaneously operating the at least two robotic arms for positioning respective vacuum ports and weed pulling assemblies in different locations for pulling multiple weeds from the soil.

37. The method of claim 23 further comprising a housing including the duct, the vacuum port having a weed entry port and a weed exit port, with a flow path therebetween, the weed entry port and the weed exit port having dimensions that enable suctioning by vacuum through the flow path.

38. The method of claim 37 in which the weed pulling assembly is positioned in fluid communication with the weed entry port and the weed exit port, the method further comprising:
applying a mechanical pulling force with the weed pulling assembly to the at least a portion of the weed drawn into the weed entry port; and
releasing the weed into the flow path toward the weed exit port.

39. The method of claim 23, in which operation of the weeding apparatus is controlled with a controller, the method further comprising:
identifying the weed and type of the weed seen with a vision system in communication with the controller, by comparison with a stored database of weed type characteristics;
determining whether or not to cut roots of the weed with a cutting assembly mounted adjacent to the vacuum port based on the type of the weed;
identifying whether or not the weed has been removed from the soil with the vision system, for determining whether or not a second attempt is needed to remove the weed.

40. The method of claim 39 further comprising maneuvering the duct over the weed with a robotic arm, path movement of the robotic arm and the duct being determined by the stored database of weed type characteristics based on the type of the weed.
